(19) United States
(12) Patent Application Publication
(10) Pub. No.: US 2020/0027105 A1
(43) Pub. Date: Jan. 23, 2020

(54) SYSTEMS AND METHODS FOR VALUE AT RISK ANOMALY DETECTION USING A HYBRID OF DEEP LEARNING AND TIME SERIES MODELS

(71) Applicant: JPMorgan Chase Bank, N.A., New York, NY (US)

(72) Inventors: Li Ling, Freehold, NJ (US); Jiafei Sun, Edison, NJ (US); Zhiqiang Gao, Westfield, NJ (US); Shahin Mahmoud Shahin, Clifton, NJ (US); Erwan Le Doeuff, Hoboken, NJ (US)

(21) Appl. No.: 16/040,673

(22) Filed: Jul. 20, 2018

(51) Int. Cl. G06Q 30/02; G06N 3/04; G06N 3/08; G06Q 40/06

(52) U.S. Cl. CPC G06Q 30/0206; G06Q 40/06; G06N 3/08; G06N 3/0472

(57) ABSTRACT

Systems and methods for Value at Risk anomaly detection using a hybrid of deep learning and time series models are disclosed. In one embodiment, in an information processing device comprising at least one computer processor, a method for Value at Risk (VaR) anomaly detection, may include: (1) calculating a current period VaR; (2) training at least one hybrid model using historical VaR calculations; (3) calculating a forecasted VaR value using the at least one hybrid model; (4) detecting an anomaly based on the current period VaR and the forecasted VaR; and (5) generating a notification in response to the detected anomaly.

### BACKGROUND OF THE INVENTION

### 1. Field of the Invention

The present disclosure generally relates to systems and methods for Value at Risk (VaR) anomaly detection using a hybrid of deep learning and time series models.

### 2. Description of the Related Art

VaR (Value at Risk) is a measure of the risk of loss (expressed either in absolute currency or percentage) of an investment(s) in a given portfolio. VaR measures this loss with a given probability given normal market conditions in a set period of time (such as a day, month or year).

Financial institutions may calculate VaR on their positions on a daily basis. Given the complexity and volumes of these calculations, it may be difficult and challenging to detect anomalies with these VaR calculations on any given day.

### SUMMARY OF THE INVENTION

Systems and methods for Value at Risk anomaly detection using a hybrid of deep learning and time series models are disclosed. In one embodiment, in an information processing device comprising at least one computer processor, a method for Value at Risk (VaR) anomaly detection, may include: (1) calculating a current period VaR; (2) training at least one hybrid model using historical VaR calculations; (3) calculating a forecasted VaR value using the at least one hybrid model; (4) detecting an anomaly based on the current period VaR and the forecasted VaR; and (5) generating a notification in response to the detected anomaly.

In one embodiment, the current period VaR may be calculated based on current and historical market data, as well as at least one of a volatility of a plurality of positions, a price of the positions, and the positions' market values.

In one embodiment, the historical VaR calculations may include prior VaR calculations for a predetermined time period.

In one embodiment, the training may be performed before the current period VaR is calculated.

In one embodiment, the hybrid model may include a combination of a traditional statistical model and a deep learning model. The traditional statistical model may include an Autoregressive Integrated Moving Average model. The deep learning model may include a Gated Recurrent Unit model, a Long Short-Term Memory model, etc.

In one embodiment, an anomaly may be detected when the current period VaR and the forecasted VaR differ by a predetermined amount.

In another embodiment, an anomaly may be detected based on a violation of at least one past VaR patterns.

According to another embodiment, a system for Value at Risk (VaR) anomaly detection may include a VaR calculation engine comprising at least one computer processor, the VaR calculation engine configured to calculate a current period VaR; and a VaR anomaly detection engine comprising at least one computer processor, the VaR anomaly detection engine configured to calculate a forecasted VaR and detect an anomaly. The VaR calculation engine may calculate the current period VaR. The VaR anomaly detection engine may train at least one hybrid model using historical VaR calculations, and may calculate the forecasted VaR value using the at least one hybrid model. The VaR anomaly detection engine may detect an anomaly based on the current period VaR and the forecasted VaR, and may generate a notification in response to the detected anomaly.

In one embodiment, the current period VaR may be calculated based on current and historical market data, as well as at least one of a volatility of a plurality of positions, a price of the positions, and the positions' market values.

In one embodiment, the historical VaR calculations may include prior VaR calculations for a predetermined time period. The training may be performed before the current period VaR is calculated.

In one embodiment, the hybrid model may include a combination of a traditional statistical model and a deep learning model. The traditional statistical model may include an Autoregressive Integrated Moving Average model. The deep learning model may include a Gated Recurrent Unit model, a Long Short-Term Memory model, etc.

In one embodiment, an anomaly may be detected when the current period VaR and the forecasted VaR differ by a predetermined amount.

In another embodiment, an anomaly may be detected based on a violation of at least one past VaR patterns.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 depicts a system for Value at Risk anomaly detection using a hybrid of deep learning and time series models according to one embodiment; and

FIG. 2 depicts a method for Value at Risk anomaly detection using a hybrid of deep learning and time series models according to one embodiment.

### DETAILED DESCRIPTION OF PREFERRED EMBODIMENTS

Embodiments disclosed herein relate to systems and methods for Value at Risk anomaly detection using a hybrid of deep learning and time series models are disclosed.

Although VaR does (and is expected to) fluctuate from day to day, it may be very difficult to detect and understand if these daily fluctuations are due to normal market conditions or due to any other scenarios or other factors. For example, VaR may vary based on changes to the financial institution's positions, market data, VaR model changes, software, etc. Therefore, drops or spikes in VaR may point to underlying issues that may need to be addressed and remediated.

One approach for being able to detect VaR anomalies is by applying the hybrid of time series and deep learning models on historical VaR data to forecast future VaR values on a daily basis and detect any anomalies by deviations from the forecasted values.

In embodiments, one or more of the following models may be used for anomaly detection: (1) Autoregressive Integrated Moving Average model (ARIMA); and (2) Recurrent Neural Network (RNN) such as Gated Recurrent Unit (GRU) and Long Short-Term Memory (LSTM). Using these models, anomalies may be detected, and alerting may be triggered to bring attention to technology and non-technology personnel for further investigation.

Statistical models, such as ARIMA, are simple, but still powerful methods for forecasting the VaR value. Recent developments of neural network techniques, such as RNN, have the promise of learning long sequences of observations and are a good match for time series forecasting problems. GRU and LSTM are two such RNNs which alleviate the vanishing gradient problem.

A brief overview of ARIMA, LSTM, and GRU is provided below.

The acronym for ARIMA is descriptive. Briefly the model is AR (Auto regressive)—a model that uses the dependent relationship between an observation and some number of lagged observations, I (Integrated)—the use of differencing of raw observations (e.g. subtracting an observation from an observation at the previous time step) in order to make the time series stationary, and MA (Moving Average)—a model that uses the dependency between an observation and a residual error from a moving average model applied to lagged observations. Each of these components is explicitly specified in the model as parameters. A standard notation is used by ARIMA (p, d, q) where the parameters are substituted with integer values to quickly indicate the specific ARIMA model being used:

p: the number of autoregressive terms;

d: the degree of difference; and

q: the order of the moving-average model.

For fitting ARIMA, the time series must be stationary. Log transformation, non-seasonal and seasonal differences are frequently used to stabilize the time series. Secondly, the autocorrelation function (ACF) graph and partial autocorrelation (PACF) graph were employed to determine the model parameters such as possible values for p, d, q. Finally, removing some unqualified models by residual tests: the residual test must show a white noise sequence.

Long Short-Term Memory (LSTM) and Gated Recurrent Unit (GRU) RNNs are among the most widely used models in Deep Learning for NLP (natural language processing) and time series today. Both LSTM and GRU are designed to combat the vanishing gradient problem that prevents standard RNNs from learning long-term dependencies through gating mechanisms.

One of the challenges faced by any anomaly detection technique is how to correlate detected anomalies with possible sources or scenarios of the anomaly (e.g., positions change, market data changes, software changes/bugs, etc.) and to understand the root cause of the anomaly. In embodiments, detected anomalies may be correlated with indicators such as, for example, last market value, software changes, and benchmark market indices. The correlation facilitates anomaly root cause investigation.

In embodiments, a hybrid model of traditional statistical models (e.g., ARIMA) and deep learning models (e.g., LSTM-RNN and GRU-RNN) may be used to fit each VaR time series. For each VaR dataset, all three models may be implemented, and the model that provides the best performance for that dataset (i.e., the least mean squared error, or MSE) may be selected.

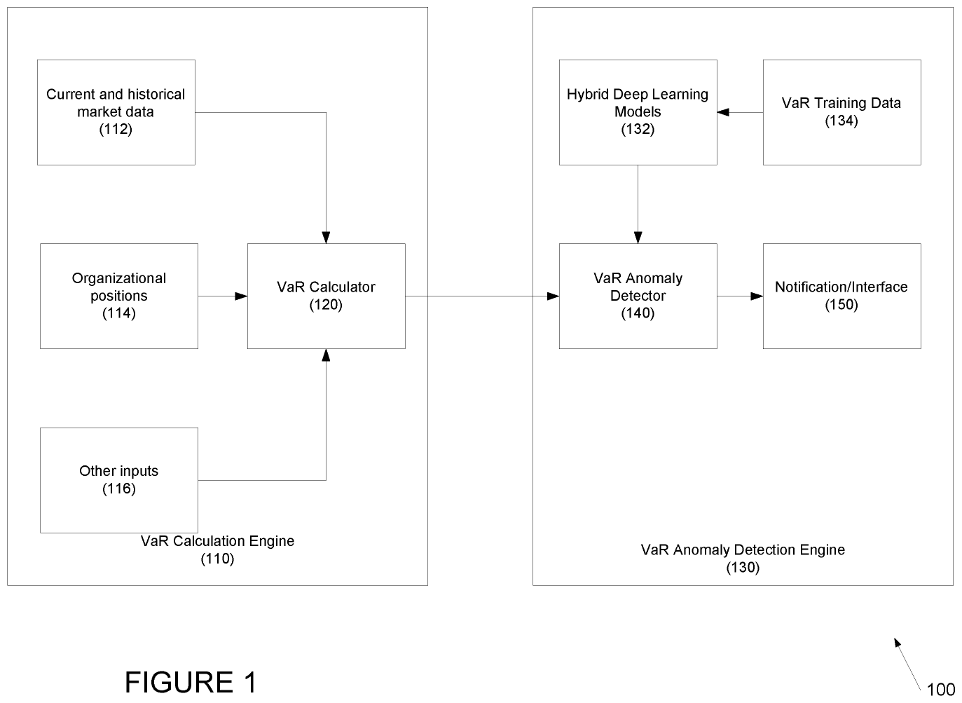

Referring to FIG. 1, a system for Value at Risk (VaR) anomaly detection is disclosed according to one embodiment. System 100 may include VaR calculation engine 110, which may include inputs, such as current and historical market data 112, organizational positions 114, and other inputs 116. In one embodiment, current and historical market data 112 may include volatility of the positions, price of the positions, bond maturities, positions' market values, etc. Organizational positions 114 may include the financial institution's positions as of a specific snapshot in time (usually the close of the current business day or the close of the previous business day). Other inputs 116 may include, for example, position sensitivities expressed as Greek quantities (delta, vega, gamma, etc.), as well as the specific VaR model calculations employed by the financial institution.

VaR calculation engine 110 may further include VaR calculator 120, which may take data from inputs 112, 114, and 116, and any other relevant input, and calculate a VaR. The VaR, and any other individual and/or aggregated calculations, may be calculated on a daily basis.

System 100 may further include VaR anomaly detection engine 130, which may include hybrid deep learning models 132, VaR training data 134, and VaR anomaly detector 140. In one embodiment, hybrid deep learning models may include, for example, a combination of traditional statistical models (e.g., ARIMA) and deep learning models (e.g., LSTM-RNN and GRU-RNN).

VaR anomaly detector 140 may receive VaR calculations from VaR calculator 120. Hybrid deep learning models 132 may receive historically-calculated VaR calculations as training data to input into the hybrid models from VaR training data 134. Hybrid deep learning models 132 may use these inputs to forecast VaR values, and may provide those forecasted VaR values to VaR Anomaly Detector 140.

In one embodiment, to start training, some or all historical data that is available may be used. After the models are trained (e.g., all the parameters and hyper parameters are optimized) and being used, the performance of the model may be monitored, using, for example, the mean squared error (MSE) metric. The models may be retrained to take into account any new VaR inputs if necessary (e.g., monthly or as otherwise necessary and/or desired).

VaR anomaly detector 140 may detect an anomaly by comparing the output from VaR calculator 120 and output from hybrid deep learning models 132, and may output an instruction to notification module 150 to notify technology and/or non-technology personnel for further investigation as is necessary and/or desired.

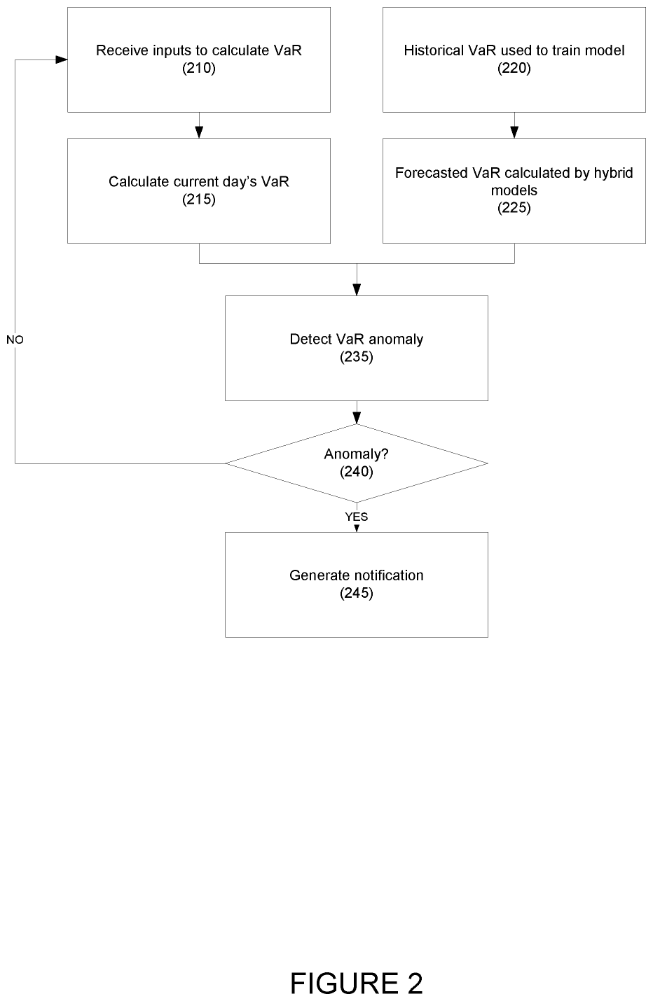

Referring to FIG. 2, a method for Value at Risk anomaly detection using a hybrid of deep learning and time series models is disclosed according to one embodiment.

In step 210, inputs are received, including current and historical market data, positions, and any other relevant data, such as the volatility of the positions, the price of the positions, bond maturities, the positions' market values, the financial institution's positions as of a specific snapshot in time (usually the close of the current business day or the close of the previous business day), position sensitivities expressed as Greek quantities (delta, vega, gamma, etc.), the specific VaR model calculations employed by the financial institution, etc.

In step 215, the current day's VaR, as well as any other VaR calculations, aggregations, etc. may be performed.

In step 220, historically-calculated VaR may be used as training data to input into the hybrid models. In one embodiment, the training may be performed daily; in another embodiment, the training may be conducted periodically; in still another embodiment, the training may be conducted as desired (e.g., when a significant change in VaR occurs, etc.)

In one embodiment, training may be conducted before the current day VaR may be calculated.

In step 225, forecasted VaR values may be calculated using the hybrid model(s). For example, the hybrid models may include a combination of traditional statistical models (e.g., ARIMA) and deep learning models (e.g., LSTM-RNN and GRU-RNN).

In step 235, the anomaly detector may then use the current day VaR and the forecasted VaR to detect any VaR anomalies.

In step 240, if a VaR anomaly is detected, in step 245, a notification may be generated and communicated (e.g., by email, SMS message, etc.) to designated individuals and/or systems. In one embodiment, the anomaly may be detected if the current VaR and the forecasted VaR differ by a predetermined amount (e.g., a percentage).

In one embodiment, the threshold may be configurable. For example, during training, a histogram may be used to determine the threshold (e.g., 99th percentile, 95th percentile, etc.). The hybrid models may track or remember the VaR sequences, and may forecast the next value based on patterns of past VaR values.

In one embodiment, an anomaly may be detected based on a violation of the past VaR patterns (which may be learned and remembered by the hybrid models).

If no anomaly is detected, the process may be repeated when the next VaR is calculated.

Hereinafter, general aspects of implementation of the systems and methods of the invention will be described.

The system of the invention or portions of the system of the invention may be in the form of a “processing machine,” such as a general purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

The processing machine used to implement the invention may utilize a suitable operating system. Thus, embodiments of the invention may include a processing machine running the iOS operating system, the OS X operating system, the Android operating system, the Microsoft Windows™ operating system, the Unix operating system, the Linux operating system, the Xenix operating system, the IBM AIX™ operating system, the Hewlett-Packard UX™ operating system, the Novell Netware™ operating system, the Sun Microsystems Solaris™ operating system, the OS/2™ operating system, the BeOS™ operating system, the Macintosh operating system, the Apache operating system, an OpenStep™ operating system or another operating system or platform.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for Value at Risk (VaR) anomaly detection, comprising:
in an information processing apparatus comprising at least one computer processor:
calculating a current period VaR;
training at least one hybrid model using historical VaR calculations;
calculating a forecasted VaR value using the at least one hybrid model;
detecting an anomaly based on the current period VaR and the forecasted VaR; and
generating a notification in response to the detected anomaly.

2. The method of claim 1, wherein the current period VaR is calculated based on current and historical market data.

3. The method of claim 2, wherein the current period VaR is further calculated based on at least one of a volatility of a plurality of positions, a price of the positions, and the positions' market values.

4. The method of claim 1, wherein the historical VaR calculations comprise prior VaR calculations for a predetermined time period.

5. The method of claim 1, wherein the training is performed before the current period VaR is calculated.

6. The method of claim 1, wherein the hybrid model comprises a combination of a traditional statistical model and a deep learning model.

7. The method of claim 6, wherein the traditional statistical model comprises an Autoregressive Integrated Moving Average model.

8. The method of claim 6, wherein the deep learning model comprises a Gated Recurrent Unit model.

9. The method of claim 6, wherein the deep learning model comprises a Long Short-Term Memory model.

10. The method of claim 1, wherein an anomaly is detected when the current period VaR and the forecasted VaR differ by a predetermined amount.

11. A system for Value at Risk (VaR) anomaly detection, comprising:
a VaR calculation engine comprising at least one computer processor, the VaR calculation engine configured to calculate a current period VaR;
a VaR anomaly detection engine comprising at least one computer processor, the VaR anomaly detection engine configured to calculate a forecasted VaR and detect an anomaly;
wherein:
the VaR calculation engine calculates the current period VaR;
the VaR anomaly detection engine trains at least one hybrid model using historical VaR calculations;
the VaR anomaly detection engine calculates the forecasted VaR value using the at least one hybrid model;
the VaR anomaly detection engine detects an anomaly based on the current period VaR and the forecasted VaR; and
the VaR anomaly detection engine generates a notification in response to the detected anomaly.

12. The system of claim 11, wherein the current period VaR is calculated based on current and historical market data.

13. The system of claim 12, wherein the current period VaR is further calculated based on at least one of a volatility of a plurality of positions, a price of the positions, and the positions' market values.

14. The system of claim 11, wherein the historical VaR calculations comprise prior VaR calculations for a predetermined time period.

15. The system of claim 11, wherein the training is performed before the current period VaR is calculated.

16. The system of claim 11, wherein the hybrid model comprises a combination of a traditional statistical model and a deep learning model.

17. The system of claim 16, wherein the traditional statistical model comprises an Autoregressive Integrated Moving Average model.

18. The system of claim 16, wherein the deep learning model comprises a Gated Recurrent Unit model.

19. The system of claim 16, wherein the deep learning model comprises a Long Short-Term Memory model.

20. The system of claim 11, wherein an anomaly is detected when the current period VaR and the forecasted VaR differ by a predetermined amount.
